(19) United States
(12) Patent Application Publication
(10) Pub. No.: US 2026/0011197 A1
(43) Pub. Date: Jan. 8, 2026

(54) MACHINE LEARNING BASED WIDTH DETECTION FOR TRANSIT SYSTEMS

(71) Applicant: Cubic Transportation Systems, Inc., San Diego, CA (US)

(72) Inventors: Steffen Reymann, Guildford (GB); Alex Tuft, Crawley (GB); Narsi Shammo, San Diego, CA (US)

(73) Assignee: Cubic Transportation Systems, Inc., San Diego, CA (US)

(21) Appl. No.: 19/258,386

(22) Filed: Jul. 2, 2025

Related U.S. Application Data
(60) Provisional application No. 63/667,435, filed on Jul. 3, 2024.

(51) Int. Cl. G07C 9/15; G01B 11/02; G06V 10/25; G06V 10/77

(52) U.S. Cl. CPC G07C 9/15; G01B 11/026; G06V 10/25; G06V 10/7715

(57) ABSTRACT

A width detection system to measure a width of an object at a transit gate of a transit system is disclosed. The width detection system includes a gate paddle to control access through the transit gate, a first gate cabinet and a second gate cabinet of the transit gate separated by an aisle width, a sensor system, and a controller. The sensor system includes a primary sensor positioned at the first gate cabinet of the transit gate. The primary sensor emits a primary signal directed at the second gate cabinet and determines a primary distance of the object to the primary sensor. The controller determines the width of the object based on the primary distance and the aisle width, compares the width against a primary threshold, and actuates the gate paddle.

### PRIORITY

This application is a non-provisional of and claims priority to U.S. Provisional Patent Application No. 63/667,435, filed Jul. 3, 2024, the contents of which is incorporated herein by reference in its entirety.

### BACKGROUND

This disclosure generally relates to a width detection system and, not by way of limitation, to width detection of an object using machine learning, among other applications.

Transit gates are used to regulate entry and exit of a transit system, such as a metro, subway, or train station. An exit gate is a type of a transit gate that allows riders to exit the transit system without requiring them to pay or validate a ticket. Exit gates facilitate the quick exit of objects, reducing congestion, especially during peak volumes. Fare evasion is a vexing problem that poses security threats and affects the revenue of the transit system. The exit gate has to allow valid exits efficiently. Gate paddles are actuated for valid riders exiting through the exit gates along with allowed objects or children.

The task of object detection at the exit gates to distinguish between valid riders and fare evaders is a complex one. Restricted coverage, challenging integration of complex designs, power consumption, and/or viewpoint variations are the common issues while detecting the object at the transit gates. During periods of peak congestion, accurate detection of valid riders helps avoid unnecessary bottlenecks. Different types of sensors are used to open the gate paddles of the exit gates for the valid riders, while keeping them closed to prevent fare evasion.

### SUMMARY

In one embodiment, the present disclosure provides a width detection system to measure a width of an object at a transit gate of a transit system is disclosed. The width detection system includes a gate paddle to control access through the transit gate, a first gate cabinet and a second gate cabinet of the transit gate separated by an aisle width, a sensor system, and a controller. The sensor system includes a primary sensor positioned at the first gate cabinet of the transit gate. The primary sensor emits a primary signal directed at the second gate cabinet and determines a primary distance of the object to the primary sensor. The controller determines the width of the object based on the primary distance and the aisle width, compares the width against a primary threshold, and actuates the gate paddle.

In an embodiment, a width detection system to measure a width of an object at a transit gate of a transit system. The width detection system includes a gate paddle to control access through the transit gate, a first gate cabinet and a second gate cabinet of the transit gate separated by an aisle width, a sensor system, and a controller. The sensor system includes a primary sensor positioned at the first gate cabinet of the transit gate. The primary sensor emits a primary signal directed at the second gate cabinet. The primary sensor determines a primary distance of the object to the primary sensor based on the primary signal reflected from the object. The sensor system further includes a secondary sensor positioned at the second gate cabinet of the transit gate. The secondary sensor emits a secondary signal directed at the first gate cabinet to determine a blocked state of the secondary sensor, a clear state of the secondary sensor, or a secondary distance of the object to the secondary sensor. The sensor system includes the primary sensor and the secondary sensor, and the primary sensor and the secondary sensor function as a cross-aisle sensor pair. The controller determines the width of the object based on the primary distance and the aisle width, compares the width against a primary threshold, and actuates the gate paddle. The controller further compares the primary distance against a secondary threshold and actuates the gate paddle if the primary distance is below the secondary threshold. The controller determines the width of the object as a function of the primary distance, the secondary distance, and the aisle width of the transit gate. The controller further processes an image corresponding to the object via a machine learning (ML) engine. The ML engine extracts features from the image and locates regions to detect the object.

In another embodiment, a width detection method for measuring a width of an object at a transit gate of a transit system. In one step, the width detection method includes controlling access through the transit gate via a gate paddle and separating a first gate cabinet and a second gate cabinet of the transit gate with an aisle width. The width detection method further includes positioning a primary sensor of a sensor system at the first gate cabinet of the transit gate. The primary sensor emits a primary signal directed at the second gate cabinet and determines a primary distance of the object to the primary sensor based on the primary signal reflected from the object. The sensor system further includes a secondary sensor positioned at the second gate cabinet of the transit gate. The secondary sensor emits a secondary signal directed at the first gate cabinet to determine a blocked state of the secondary sensor, a clear state of the secondary sensor, or a secondary distance of the object to the secondary sensor. The sensor system includes the primary sensor and the secondary sensor, and the primary sensor and the secondary sensor function as a cross-aisle sensor pair. The width detection method further includes determining the width of the object, via a controller, based on the primary distance and the aisle width. The controller compares the width against a primary threshold and actuates the gate paddle. The controller further compares the primary distance against a secondary threshold and actuates the gate paddle if the primary distance is below the secondary threshold. The controller determines the width of the object as a function of the primary distance, the secondary distance, and the aisle width of the transit gate. The controller further processes an image corresponding to the object via a machine learning (ML) engine. The ML engine extracts features from the image and locates regions to detect the object.

In yet another embodiment, a machine-readable medium having machine-executable instructions embodied thereon that, when executed by one or more processors, facilitate a method for measuring a width of an object at a transit gate of a transit system. In one step, the method includes controlling access through the transit gate via a gate paddle and separating a first gate cabinet and a second gate cabinet of the transit gate with an aisle width. The method further includes positioning a primary sensor of a sensor system at the first gate cabinet of the transit gate. The primary sensor emits a primary signal directed at the second gate cabinet and determines a primary distance of the object to the primary sensor based on the primary signal reflected from the object. The sensor system further includes a secondary sensor positioned at the second gate cabinet of the transit gate. The secondary sensor emits a secondary signal directed at the first gate cabinet to determine a blocked state of the secondary sensor, a clear state of the secondary sensor, or a secondary distance of the object to the secondary sensor. The primary sensor and the secondary sensor of the sensor system function as a cross-aisle sensor pair. The method further includes determining the width of the object, via a controller, based on the primary distance and the aisle width. The controller compares the width against a primary threshold and actuates the gate paddle. The controller further compares the primary distance against a secondary threshold and actuates the gate paddle if the primary distance is below the secondary threshold. The controller determines the width of the object as a function of the primary distance, the secondary distance, and the aisle width of the transit gate. The controller further processes an image corresponding to the object via a machine learning (ML) engine. The ML engine extracts features from the image and locates regions to detect the object.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a width detection system to measure a width of an object at a transit gate;

FIG. 2 illustrates a detection workflow via a machine learning (ML) engine;

FIG. 3 illustrates a front perspective view of the transit gate including a sensor system and a camera;

FIG. 4 illustrates an access violation of the object concealing a sensor from an adjacent aisle of the transit gate;

FIG. 5 illustrates a front view of the transit gate with the object transiting through the transit gate;

FIG. 6A illustrates a primary mounting setup for a primary sensor at a first gate cabinet;

FIG. 6B illustrates a secondary mounting setup for a secondary sensor at a second gate cabinet;

FIG. 7 illustrates a width detection method for measuring the width of the object and actuating a gate paddle;

FIG. 8 illustrates a distance comparison to actuate the gate paddle, and

FIG. 9 illustrates a width comparison to actuate the gate paddle;

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

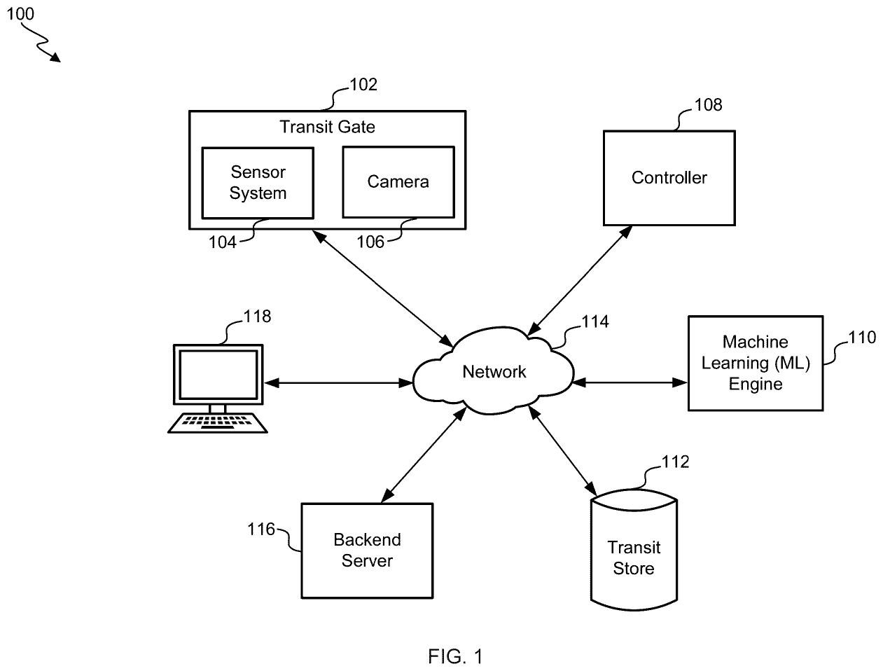

Referring to FIG. 1, a width detection system 100 to measure a width of an object at a transit gate 102 is shown as an embodiment. The width detection system 100 tracks fare evasion behaviors of the object at the transit gate 102. The object is a rider or a passenger transiting through the transit gate 102, alone or accompanied by objects such as a stroller, luggage, dogs, or a bicycle. The transit gate 102 regulates access to the compensated sections of the transit system. The width detection system 100 tracks the object with wrong entry through the transit gate 102. The width detection system 100 detects other objects, such as boxes or packages, thrown by the riders to unlock the transit gate 102 unauthorizedly from the opposite side of a gate aisle or an ingress aisle. The width detection system 100 recognizes forcing of the gate paddles or the riders loitering in the gate aisle. The width detection system 100 measures the width of the object at the transit gate 102 to actuate the gate paddles only for valid riders. The width detection system 100 includes the transit gate 102, a controller 108, a machine learning (ML) engine 110, a transit store 112, a network 114, a backend server 116, and a node 118. The width detection system 100 further includes a sensor system 104 and a camera 106, positioned at the surfaces of the transit gate 102.

The transit gate 102 allows the riders to transit within the transit system when they have a valid ticket, token, card, or code. The transit gate 102 is equipped with fare media readers and barrier mechanisms or gate paddles. A gate paddle controls access through the transit gate 102. The transit gate 102 actuates the gate paddle to manage the flow of the objects. The transit gate 102 utilizes swinging paddles, retractable barriers, high-entry/exit gates, pop-up barriers, or optical turnstiles as the gate paddle. An exit gate is a type of gate that facilitates the exit of the riders from the transit system without requiring them to pay or validate their tickets, cards, or codes. Exit gates facilitate the quick exit of the objects (riders), reducing congestion during peak volumes. The exit gates detect the presence of the riders using different sensors. The gate paddles of the exit gates are actuated when the riders approach within the gate aisle, allowing a continuous stream of the objects flow, especially during peak hours. The gate aisle is a passageway of the transit gate 102, controlled by the gate paddle that opens or closes to control access through the transit system.

Fare evasion at the exit gate is a problem that impacts the transit system in several ways. Fare evaders cause revenue losses, damage the reputation of the transit system, pose security threats, and affect the quality and frequency of transit services. During fare evasion at the exit gate, the rider throws some objects, such as a box or a package, from the opposite side of the gate aisle or the ingress aisle. The exit gate detects the presence of the rider and triggers the gate paddle to unlock, allowing fare evaders to pass through. In other scenarios, the riders attempt to obscure sensors of the exit gate using other objects like a hat, an umbrella, or a hand wave. The sensors interpret these objects as the presence of the rider based on their readings and actuate the gate paddle to allow a transit through the exit gate. From hereinafter, the terms “transit gate” and “exit gate” are used interchangeably. The exit gate 102 features a gate paddle to control access through the gate. The exit gate 102 features a first gate cabinet and a second gate cabinet, separated by an aisle of the specified width. The exit gate 102 of the width detection system 100 is equipped with the sensor system 104 and the camera 106.

The sensor system 104 is positioned at the exit gate 102 to sense the object's presence and determine the width of the object at the exit gate 102. The sensor system 104 converts physical phenomena such as motion, presence, position, or distance of the object into electrical signals. The sensor system 104 facilitates the controller 108 to make decisions based on predefined threshold criteria. The sensor system 104 includes a primary sensor and a secondary sensor, positioned at the first gate cabinet and at the second gate cabinet of the exit gate 102, respectively. The primary sensor emits a primary signal and determines a primary distance of the object to the primary sensor based on the primary signal reflected from the object. The secondary sensor emits a secondary signal directed at the first gate cabinet. The secondary sensor determines a blocked state of the secondary sensor, a clear state of the secondary sensor, or a secondary distance of the object to the secondary sensor. The blocked state indicates that the secondary signal of the secondary sensor is interrupted by the object and the object is in a proximity to the exit gate 102. The clear state indicates that the secondary signal of the secondary sensor is uninterrupted. Based on the primary distance and the secondary distance, the camera 106 captures an image of the object at the exit gate 102.

The camera 106 captures the image corresponding to the object. In an embodiment, the camera 106 captures frames at a frame rate such as 50 frames per second. The camera 106 features a fixed or adjustable lens, offering options for various focal lengths and apertures to control the field of view at the exit gate 102. In another embodiment, the camera 106 captures high-resolution still images at predefined intervals or in response to specific events. The camera 106 stores captured images in its internal storage, such as a secure digital (SD) card, or in the transit store 112 through the network 114. The camera 106 sends the image to the controller 108 for further processing.

The controller 108 takes the primary distance and the secondary distance of the object and actuates the gate paddle. The controller 108 determines the width of the object based on the primary distance and the aisle width. In an embodiment, the controller 108 determines the width of the object as a function of the primary distance, the secondary distance, and the aisle width of the transit gate 102. The controller 108 compares the width against a primary threshold and actuates the gate paddle if the width exceeds the primary threshold. The primary threshold is a primary reference voltage set by using a voltage divider or a voltage source. The primary threshold is a reference width of the object. In another embodiment, the controller 108 compares the primary distance against a secondary threshold and actuates the gate paddle if the primary distance is below the secondary threshold. The secondary threshold is a secondary reference voltage set by using the voltage divider or the voltage source. The secondary threshold is a reference distance at which the object, when positioned below it, triggers the controller 108 to actuate the gate paddle.

The controller 108 includes a comparator that compares the width against the primary threshold or compares the primary distance against the secondary threshold. In an embodiment, the controller 108 is a microcontroller (uC) such as ruggeduino or a standard arduino. The controller 108 is a pi pico automation 2040 or a pi pico with a 24V analog-to-digital converter (ADC) and 24V positive-negative-positive (PNP) level shifters. In another embodiment, the controller 108 is a combination of the uC and a programmable automation controller (PAC). The PAC leverages the microcontroller's ability to perform dedicated tasks such as width measurements, comparisons against thresholds, and emulating sensor signals to the PAC. The PAC actuates the gate paddle based on the primary threshold, the secondary threshold, the width measurement, and processing of the image via the ML engine 110.

In an embodiment, if the width or the primary distance does not meet the predefined threshold criteria, the controller 108 signals the ML engine 110 to process the image captured via the camera 106. The ML engine 110 preprocesses the image captured via the camera 106, extracts features from the image, and locates regions of the image to detect the object. The ML engine 110 obtains the images from the internal storage of the camera 106 or from the transit store 112. The transit store 112 saves images along with their annotations, such as class labels, edges, 3D bounding boxes, object geometry, or segmentations. In an embodiment, the transit store 112 is a relational database that uses structured query language (SQL). In some embodiments, the transit store 112 is a graph database, a time-series database, a spatial database, a file-based storage, or a cloud storage.

The transit store 112 serves as a repository for the images captured at the exit gate 102. The ML engine 110 accesses the images in the transit store 112 and annotates prediction outcomes. The ML engine 110 locates the regions of the image to detect the object at the exit gate 102. The ML engine 110 handles the unstructured or sparse segments of the images, extracts different features of the objects from the images, and generates 3D bounding boxes. The ML engine 110 provides the prediction outcomes to the controller 108, enabling the controller 108 to determine whether to actuate the gate paddle or to keep it closed. The ML engine 110 further stores the prediction outcomes in the transit store 112 via the network 114.

The network 114 communicatively couples the exit gate 102 with the node 118, the backend server 116, and the transit store 112. The network 114 facilitates the transfer of the images and other data within the width detection system 100. In an embodiment, the network 114 is a wired network, such as a local area network (LAN), ethernet cable, or a fiber-optic cable. In another embodiment, the network 114 is a wireless network that uses radio waves or infrared signals for communication. The backend server 116 handles data storage in the transit store 112 and data retrieval from the transit store 112. The backend server 116 connects with payment gateways and manages authentication and access control to the node 118. The node 118 displays the image on a screen attached to the node 118 or provides system notifications based on comparisons against predefined thresholds. The node 118 executes instructions from software applications and features components such as processors, node sensors, user interfaces, and hardware resources. The node 118 is a computer, a laptop, a mobile phone, a tablet, a console, or an internet-of-things (IoT) device with an authorized identity and restricted access in the width detection system 100.

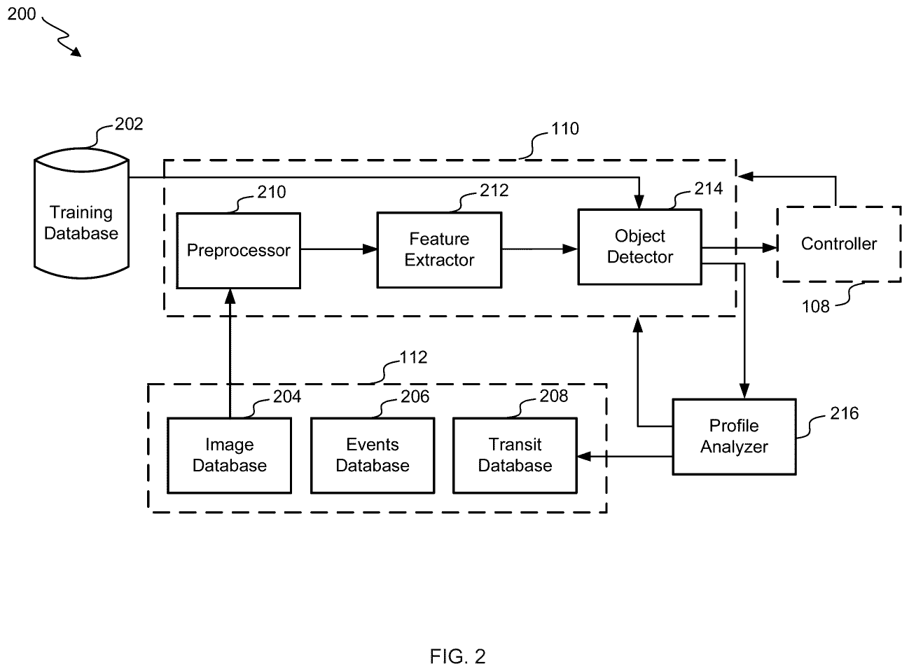

Referring next to FIG. 2, a detection workflow 200 via the machine learning (ML) engine 110 is shown as an embodiment. The detection workflow 200 includes the ML engine 110 that processes the image to detect the object at the exit gate 102. The detection workflow 200 updates engine parameters upon encountering an error in the object detection. The detection workflow 200 includes a training database 202, the controller 108, the ML engine 110, the profile analyzer 216, and the transit store 112. The transit store 112 further includes an image database 204, an event database 206, and a transit database 208. The ML engine 110 further includes a preprocessor 210, a feature extractor 212, and an object detector 214.

The image database 204 stores the images captured via the camera 106 at defined intervals or frame rates. The image database 204 stores images, including image metadata such as timestamps, transit gate locations, capture settings, and camera identities (IDs). For image storage and retrieval, the image database 204 uses compression, archiving, and indexing mechanisms. The event database 206 stores events related to the width measurements and detected objects at the transit gate 102. The event database 206 stores both false detections and true detections, along with corresponding decisions made by the controller 108 and timeline-based occurrences. The event database 206 stores where the detected objects deviate from known objects or the training dataset. The events are stored along with event metadata such as the width measurement, object type, detection confidence level, and the decision taken by the controller 108 regarding gate paddle actuation.

The transit database 208 manages and stores data related to riders' entry and exit, including rider ID and fare type. Additionally, the transit database 208 stores transaction details, insights into peak volumes, revenue generation information, and system performance data. The transit store 112 serves as a repository for the images, enabling the controller 108 to process them via the ML engine 110. The ML engine 110 processes the image captured via the camera 106, extracts features from the image, and locates the regions of the image to detect the object at the exit gate 102.

The preprocessor 210 of the ML engine 110 transforms the image into usable formats. The preprocessor 210 reduces noise, adjusts contrast and brightness, and normalizes pixel values of the image. The preprocessor 210 divides the image into segments to isolate the object of interest from the background. The feature extractor 212 uses normalized and segmented pixel values of the image to extract different features of the object at the exit gate 102. In an embodiment, the feature extractor 212 applies signal processing to extract frequency components from the pixel values. In another embodiment, the feature extractor 212 applies computer vision or statistical methods to extract texture features, edge patterns, and color distributions in a preprocessed image. The ML engine 110 utilizes these features to locate regions for object detection.

The object detector 214 is trained on the features and training images from the training database 202. The training database 202 includes the training images of the object at the exit gate 102. Examples of the training images include, but are not limited to, the rider alone or accompanied by free-riding children, the rider carrying a backpack, or the bicycle in front of the rider and close contact with the sensor system 104. In an embodiment, the object detector 214 generates region proposals to predict bounding boxes and locate the regions of interest in the image. In another embodiment, the object detector 214 predicts the bounding boxes and class scores directly from feature maps of the different features at multiple scales. The object detector 214 identifies if the object at the exit gate 102 belongs to a category of valid riders.

The object detector 214 provides a detection outcome to the controller 108 to decide regarding the gate paddle actuation. The object detector 214 signals the profile analyzer 216 to assess the detection. The profile analyzer 216 assesses the objects detected by the ML engine 110 and analyzes errors. The errors include misclassifications. The profile analyzer 216 compares the detection outcomes against ground truth labels and calculates metrics, such as precision, recall, and F1-score to identify discrepancies. The profile analyzer 216 investigates errors and tunes engine parameters, such as learning rate, feature weights, and other hyperparameters.

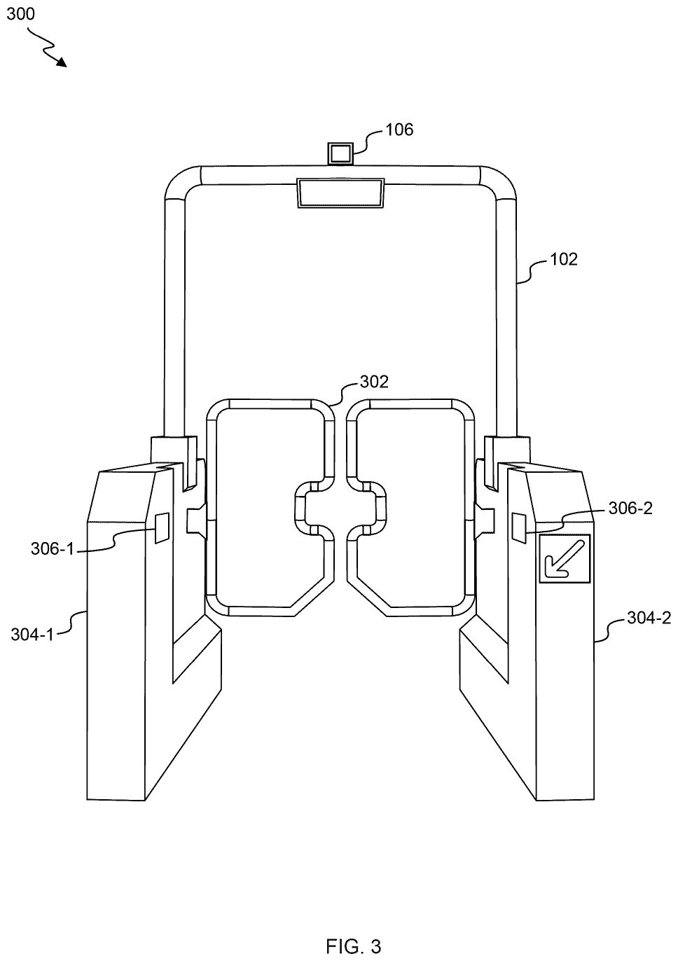

Referring to FIG. 3, a front perspective view 300 of the transit gate 102 including the sensor system 104 and the camera 106, is shown as an embodiment. The front perspective view 300 shows the exit gate 102, the camera 106, a gate paddle 302, a first gate cabinet 304-1, and a second gate cabinet 304-2. The front perspective view 300 further shows a primary sensor 306-1 positioned at the first gate cabinet 304-1 and a secondary sensor 306-2 positioned at the second gate cabinet 304-2.

The gate paddle 302 controls access through the exit gate 102. The gate paddle 302 actuates for authorized or valid riders. The first gate cabinet, 304-1, and the second gate cabinet, 304-2, are separated by the aisle width to form the gate aisle. The gate aisle is the passageway within the exit gate 102, controlled by the gate paddle 302, which opens or closes to regulate access through the exit gate 102. In some embodiments, the gate paddle 302 is a retractable flap, a swing gate, or a tripod. In another embodiment, the gate paddle 302 is a single door barrier made from stainless steel or glass. In yet another embodiment, the gate paddle 302 is a double-door barrier with a wide aisle gate (WAG) to accommodate riders with luggage, strollers, bicycles, or other objects. Through the sensor system 104 and the camera 106, the width detection system 100 measures the width, distance, and position of objects transiting through the WAG of the exit gate 102 to prevent fare evasion.

The primary sensor 306-1 emits the primary signal directed at the second gate cabinet 304-2, receives the reflected signal, and measures the time interval between the emission of the primary signal and its reception. The primary sensor 306-1 filters out the noise and determines the primary distance of the object to the primary sensor 306-1 based on the primary signal reflected from the object. In an embodiment, the primary sensor 306-1 is an ultrasonic sensor that measures the time it takes for an echo to return after bouncing off the object. In some other embodiments, the primary sensor 306-1 is an infrared sensor, a capacitive sensor, a magnetic sensor, an optical triangulation sensor, or a laser rangefinder.

In an embodiment, the primary sensor 306-1 is a time-of-flight (ToF) sensor, which measures the time it takes for the light pulse to travel to the object and return. The primary sensor 306-1 emits the primary signal as the light pulse directed at the second gate cabinet 304-2. The primary signal travels within the gate aisle and reflects off the object present in the WAG of the exit gate 102. The primary sensor 306-1 measures the time interval between the emission and reception of the primary signal, determining the primary distance of the object to the primary sensor 306-1. The primary sensor 306-1 is an analog ToF sensor, providing an analog output as a voltage signal or a voltage level. The voltage level is proportional to the primary distance of the object from the primary sensor 306-1. In another embodiment, the primary sensor 306-1 is a zonal ToF sensor, capable of measuring distances in multiple zones simultaneously.

The secondary sensor 306-2 is positioned at the second gate cabinet 304-2 and emits the secondary signal directed at the first gate cabinet 304-1. In an embodiment, the secondary sensor 306-2 is a binary sensor that detects two mutually exclusive states, such as “present” or “absent”. In another embodiment, the secondary sensor 306-2 is a beam sensor that detects the presence or absence of an object by interrupting a beam of light. In yet another embodiment, the secondary sensor 306-2 uses similar technology to the primary sensor 306-1.

In an embodiment, the primary sensor 306-1 is the ToF sensor, and the secondary sensor 306-2 is the beam sensor. The primary sensor 306-1 and the secondary sensor 306-2 function as a cross-aisle sensor pair. The cross-aisle sensor pair determines the state of the secondary sensor 306-2 and the primary distance of the object from the primary sensor 306-1. The secondary sensor 306-2 emits a continuous beam of light as the secondary signal, directed at the first gate cabinet 304-1. As long as the object is absent from the gate aisle, the secondary sensor 306-2 maintains its clear state. The clear state indicates that the secondary signal remains uninterrupted. Based on the clear state, the controller 108 compares the primary distance against the secondary threshold and keeps the gate paddle 302 locked as the primary distance exceeds the secondary threshold. In another embodiment, the primary sensor 306-1 and the secondary sensor 306-2 are both ToF sensors. The cross-aisle sensor pair determines the primary distance and the secondary distance between the object and the sensor system 104.

In an embodiment, a time buffer algorithm is used for the cross-aisle sensor pair. The time buffer algorithm provides a grace period or controlled delay between the primary sensor 306-1 and the secondary sensor 306-2 operations. The time buffer algorithm avoids signal interference between the primary signal and the secondary signal by alternating activation times of the primary sensor 306-1 and the secondary sensor 306-2. For example, when the controller 108 gets triggered by the blocked state of the secondary sensor 306-2, the controller 108 waits for the buffer to collect a synchronized voltage signal from the primary sensor 306-1. The time buffer algorithm prevents the controller 108 from triggering falsely due to a timing mismatch in the sensor system 104.

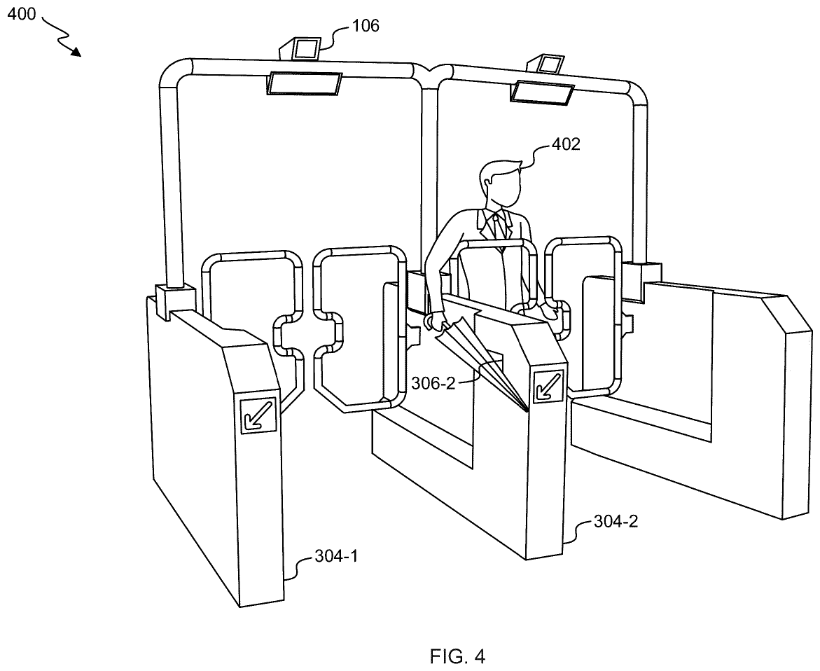

Referring next to FIG. 4, an access violation 400 of an object 402 concealing a sensor from an adjacent aisle of the transit gate 102, is shown as an embodiment. The adjacent aisle provides access to the transit system and manages ingress flow for the valid riders. The adjacent aisle is the gate aisle of an adjacent exit gate. The object 402 conceals the sensor of the exit gate 102 by using other objects, such as an umbrella, backpack, box, or hand wave, to evade fare in the transit system from the adjacent aisle.

In an embodiment, the secondary sensor 306-2 is the beam sensor, and the object 402 conceals the secondary sensor 306-2 with the umbrella. As the secondary sensor 306-2 gets covered, the secondary signal is interrupted. The blocked state of the secondary sensor 306-2 triggers the controller 108 to actuate the gate paddle 302 of the exit gate 102. The controller 108 reads the primary distance from the primary sensor 306-1 and compares the primary distance against the secondary threshold. As the object 402 itself is not present in the gate aisle of the exit gate 102 and is trying to evade fare from the adjacent aisle, the primary distance exceeds the secondary threshold. The controller 108 restricts gate access by keeping the gate paddle 302 closed.

In an embodiment, the secondary sensor 306-2 is the beam sensor, and the object 402 conceals the primary sensor 306-1 with the umbrella. The controller 108 reads the primary distance and compares it against the secondary threshold. As the object 402 holds the umbrella close to the primary sensor 306-1, the primary distance falls below the secondary threshold, fulfilling the condition for actuation of the gate paddle 302. The controller 108 reads the state of the secondary sensor 306-2. The secondary sensor 306-2 determines the clear state of the secondary sensor 306-2, and the controller 108 again restricts the gate access by keeping the gate paddle 302 closed. In another embodiment, the primary sensor 306-1 and the secondary sensor 306-2 are both ToF sensors. The object 402 conceals one of these sensors. The controller 108 determines the width of the object based on the primary distance, aisle width, and the secondary distance. The controller 108 again restricts the gate access as the width falls below the primary threshold.

In an embodiment, the object 402 is waving the umbrella or hand in the gate aisle to block both the primary sensor 306-1 and the secondary sensor 306-2. The secondary sensor 306-2, also known as the beam sensor, determines the blocked state of the secondary sensor 306-2 when the secondary signal is interrupted. The controller 108 reads the primary distance from the primary sensor 306-1 and compares it against the secondary threshold. As the object 402 waves the umbrella, the primary distance and hence the comparison of the primary distance against the secondary threshold are either unstable or the primary distance reaches the secondary threshold. The controller 108 signals the camera 106 to capture the image corresponding to the object 402 and sends the captured image to the ML engine 110 for processing. The ML engine 110 detects the object and helps the controller 108 restricts gate access for fare evaders.

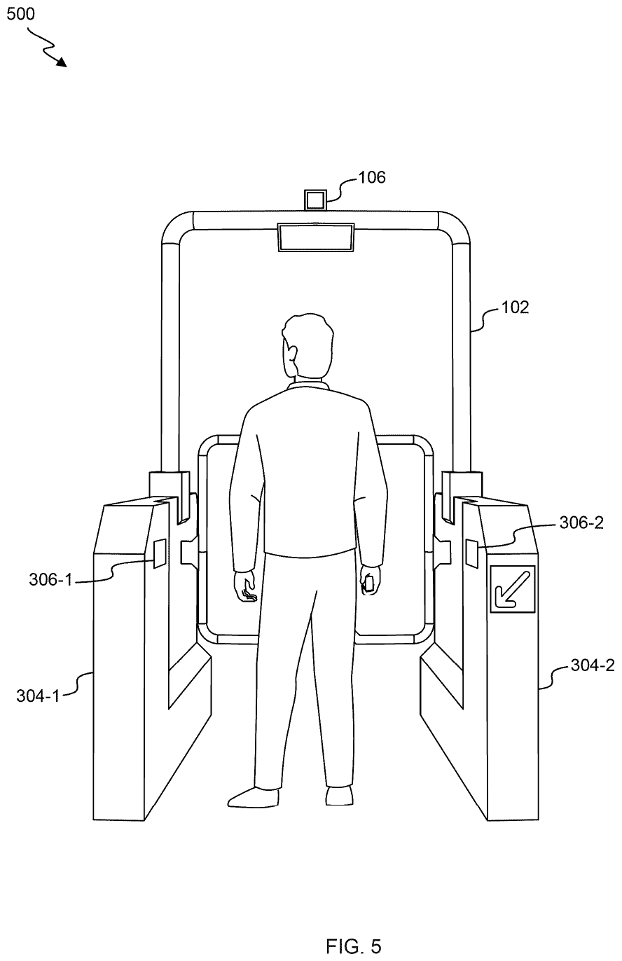

Referring next to FIG. 5, a front view 500 of the transit gate 102 with the object 402 transiting through the transit gate 102 is shown as an embodiment. The front view 500 shows the rider exiting through the exit gate 102. In an embodiment, the object 402 arrives in the gate aisle and interrupts the secondary signal. The secondary sensor 306-2 determines the blocked state of the secondary sensor 306-2 and triggers the controller 108. The controller 108 determines the voltage i.e., the primary distance from the primary sensor 306-1 and compares the primary distance against the secondary threshold. As the object 402 is present in the gate aisle, the primary distance is below the secondary threshold and the controller 108 actuates the gate paddle 302.

In an embodiment, the controller 108 determines the width of the object 402 as the function of the primary distance, the secondary distance, and the aisle width of the exit gate 102. The controller 108 compares the width against the primary threshold and actuates the gate paddle 302 if the width exceeds the primary threshold. In another embodiment, the controller 108 gets triggered by the primary distance and the secondary distance and then signals the ML engine 110 to process the image. The ML engine 110 recognizes if the controller 108 is being triggered for the valid riders by detecting the riders from the image at the exit gate 102. The gate paddle 302 is actuated based on the primary threshold, the secondary threshold, or processing of the image based on the primary threshold and the secondary threshold.

In an embodiment, the controller 108 deals with edge cases. By using the time-buffer algorithm, the controller 108 facilitates the grace period for the sensor system 104 to be triggered for the object 402. For example, if the object 402 is using a wheelchair, a bicycle, or carrying a stroller, the width comparison or the primary distance comparison remains unmet. The controller 108 triggers the camera 106 to capture the image corresponding to the object 402. The ML engine 110 detects the validity of the object 402. The time-buffer algorithm further prevents accidental triggering in the middle of the gate aisle due to an overlap between the primary signal and the secondary signal, or due to direct blocking of the ToF sensors. In another embodiment, the triggers to the controller 108 from the primary sensor 306-1 or the secondary sensor 306-2 are retained for a configurable period to prevent spiking.

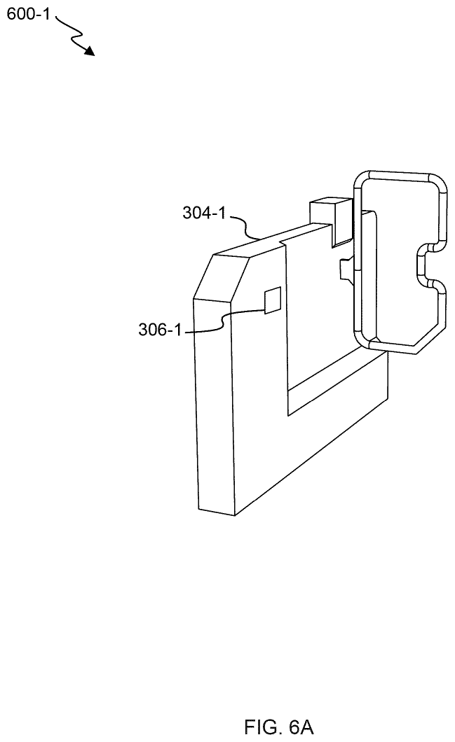

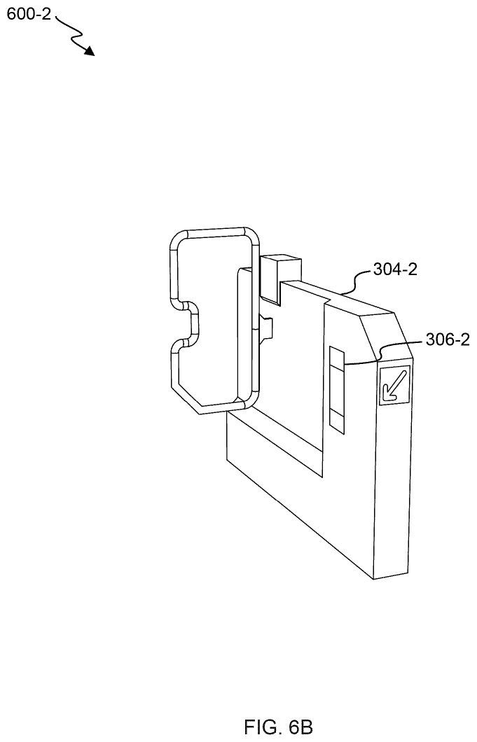

Referring next to FIG. 6A, a primary mounting setup 600-1 for the primary sensor 306-1 at the first gate cabinet 304-1 is shown as an embodiment. The primary mounting setup 600-1, utilizes existing cutouts of beam sensors at the transit gates for the primary sensor, 306-1. The primary mounting setup 600-1 uses brackets to mount the primary sensor 306-1 at the cutouts of the beam reflectors at the existing transit gate. In an embodiment, the primary sensor 306-1 and the uC of the controller 108 are both mounted using mounting brackets at the exit gate 102. The mounting of the primary sensor 306-1 is angled down or angled out to angle the primary signal of the primary sensor 306-1.

Referring to FIG. 6B, a secondary mounting setup 600-2 for the secondary sensor 306-2 at the second gate cabinet 304-2 is shown as an embodiment. The secondary mounting setup 600-2 utilizes the existing cutouts of the sensors at the transit gates. In an embodiment, the secondary mounting setup 600-2 replaces the existing beam sensors of the transit gate 102 with the ToF sensors. While mounting the ToF sensors as the primary sensor 306-1 or as the secondary sensor 306-2, a horizontal alignment of the ToF sensors is checked. The ToF sensor points towards the existing beam sensor of the exit gate 102. In another embodiment, the mounting of the secondary sensor 306-2 is angled down or angled out to angle the secondary signal.

In an embodiment, the sensor system 104 is installed at the exit gate 102 through a retrofitting process. The retrofitting mounts the sensor system 104 and the uC of the controller 108 in existing transit gates. The cable looms and the brackets for mounting the sensor system 104 are designed after checking the mounting setups. In another embodiment, width detection of the object is made an inherent part of the design by integrating the sensor system 104 and the controller 108 in the new transit gates.

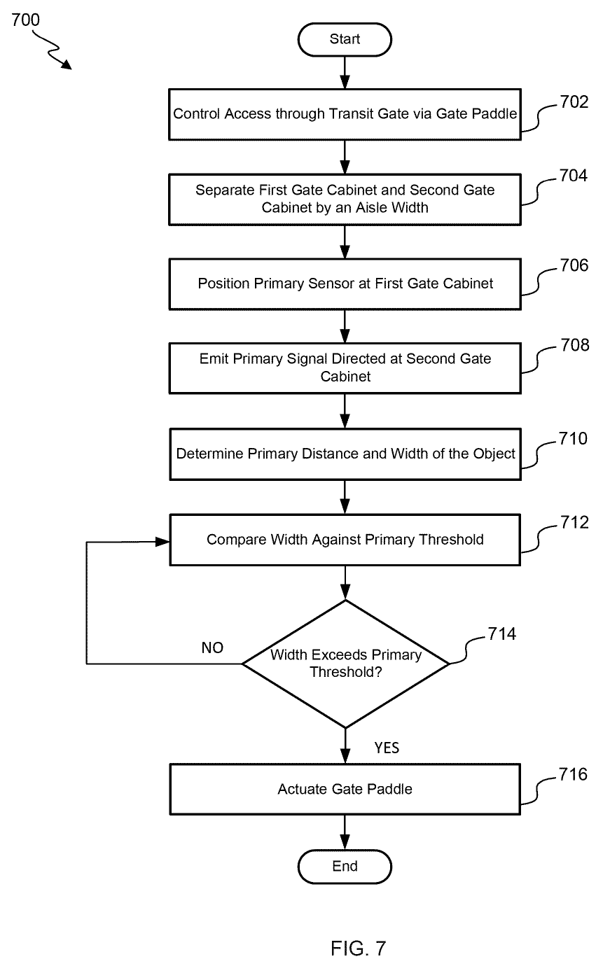

Referring next to FIG. 7, a width detection method 700 for measuring the width of the object 402 and actuating the gate paddle 302 is shown as an embodiment. The width detection method 700 involves measuring the width of the object 402 and actuating the gate paddle 302 based on the comparison of the width against the primary threshold. At block 702, the gate paddle 302 controls access through the transit gate 102. The gate paddle 302 opens for the valid riders and restricts access for the fare evaders in the transit system. At block 704, the first gate cabinet 304-1 and the second gate cabinet 304-2 are separated by the aisle width. The aisle width indicates the width of the passageway.

At block 706, the primary sensor 306-1 is positioned at the first gate cabinet 304-1. At block 708, the primary sensor 306-1 emits the primary signal directed at the second gate cabinet 304-2. The primary signal interacts with the object 402 present in the gate aisle and returns to the primary sensor 306-1. At block 710, the primary distance and the width of the object 402 is determined. The primary sensor 306-1 determines the primary distance of the object 402 to the primary sensor 306-1 based on the primary signal reflected from the object 402. The primary sensor 306-1 receives the reflected signal and measures the time interval between the emission of the primary signal and its reception. The controller 108 determines the width of the object 402 based on the primary distance and the aisle width. The controller 108 determines the width of the object as a function of the primary distance, the secondary distance, and the aisle width of the exit gate 102.

At block 712, the controller 108 compares the width of the object 402 against the primary threshold. The primary threshold is the primary reference voltage, set by using the voltage divider or the voltage source. At block 714, the width detection method 700 checks if the width exceeds the primary threshold. If the width of the object 402 exceeds the primary threshold, the width detection system 100 actuates the gate paddle 302 at block 716. If the width of the object 402 falls short of the primary threshold, the controller 108 continues to compare the width of the object 402 at the block 712.

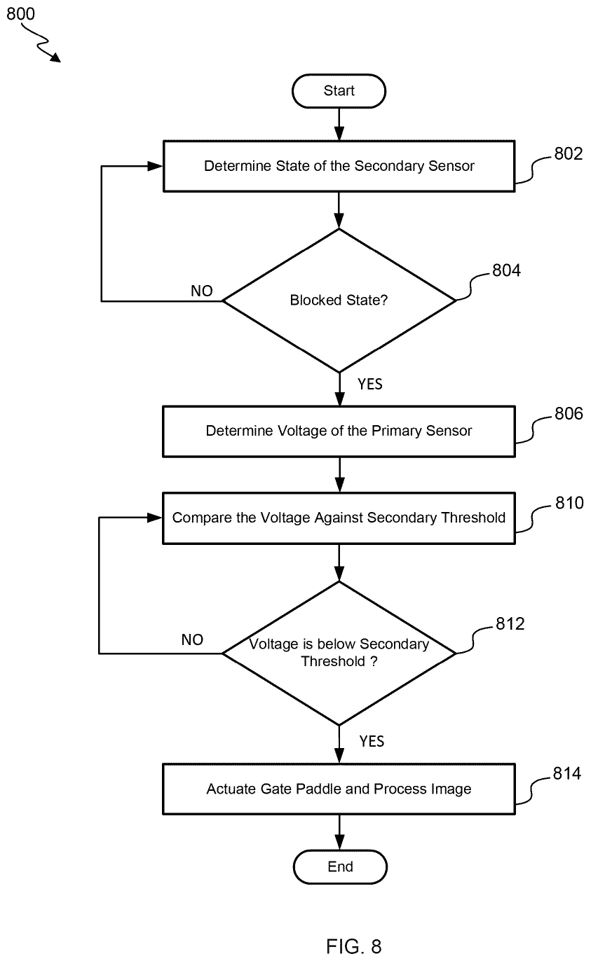

Referring next to FIG. 8, a distance comparison 800 to actuate the gate paddle 302 is shown as an embodiment. For the distance comparison 800, the primary sensor 306-1 is the ToF sensor and the secondary sensor 306-2 is the beam sensor. At block 802, the state of the secondary sensor 306-2 is determined. If the object 402 is present in the gate aisle, the secondary sensor 306-2 determines the blocked state of the secondary sensor 306-2. If the object 402 is absent from the gate aisle, the state of the secondary sensor 306-2 is determined to be the clear state. At block 804, the controller 108 checks if the secondary sensor 306-2 is determining the blocked state. If so, the controller 108 determines the voltage of the primary sensor 306-1 at block 806. The voltage is proportional to the primary distance of the object 402 from the primary sensor 306-1 in the gate aisle. At block 810, the controller 108 compares the voltage against the secondary threshold. At block 812, the controller 108 checks if the voltage is below the secondary threshold. If so, the width detection system 100 actuates the gate paddle 302 and signals the ML engine 110 to process the image at block 814. Otherwise, the controller 108 continues to compare the voltage against the secondary threshold at block 810, as long as the object 402 remains present in the gate aisle and the secondary sensor 306-2 determines the blocked state.

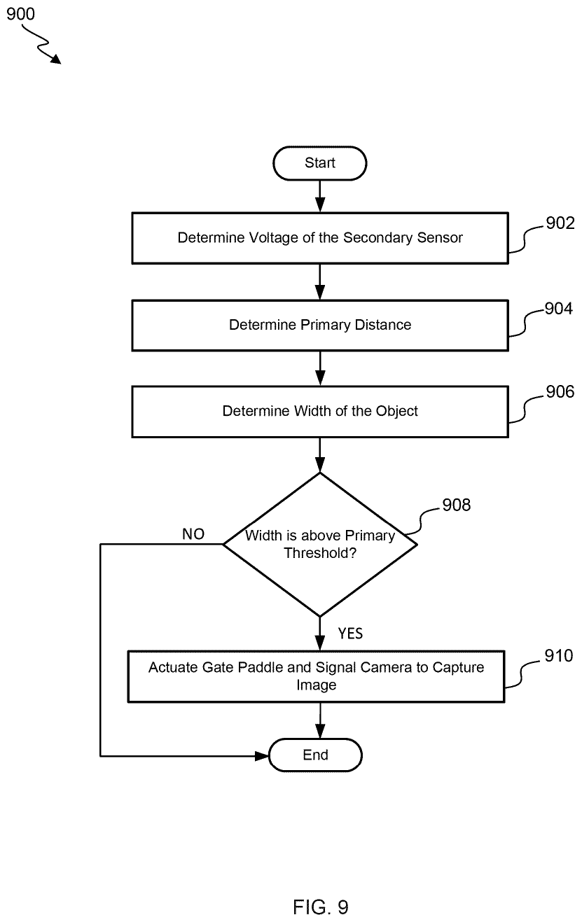

Referring next to FIG. 9, a width comparison 900 to actuate the gate paddle 302 is shown as an embodiment. For the width comparison 900, the primary sensor 306-1 and the secondary sensor 306-2 are both ToF sensors. At block 902, the controller 108 determines the voltage of the secondary sensor 306-2. As the secondary sensor 306-2 is the ToF sensor, the voltage is proportional to the secondary distance of the object 402 from the secondary sensor 306-2. At block 904, the primary sensor 306-1 determines the primary distance of the object 402 from the primary sensor 306-1 in the gate aisle. At block 906, the controller 108 determines the width of the object 402 as the function of the primary distance, the secondary distance, and the aisle width. At block 908, the controller 108 compares the width of the object 402 against the primary threshold and checks if the width is above the primary threshold. If so, the controller 108 actuates the gate paddle 302 and signals the camera 106 to capture the image at block 910.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic-devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A width detection system to measure a width of an object at a transit gate of a transit system, the width detection system comprises:
a gate paddle to control access through the transit gate;
a first gate cabinet and a second gate cabinet of the transit gate, separated by an aisle width;
a sensor system comprising a primary sensor positioned at the first gate cabinet of the transit gate, and wherein the primary sensor:
emits a primary signal directed at the second gate cabinet, and
determines a primary distance of the object to the primary sensor based on the primary signal reflected from the object; and
a controller, wherein the controller:
determines the width of the object based on the primary distance and the aisle width,
compares the width against a primary threshold, and
actuates the gate paddle.

2. The width detection system to measure the width of the object at the transit gate of the transit system of claim 1, wherein the sensor system further comprises a secondary sensor positioned at the second gate cabinet of the transit gate, and wherein the secondary sensor emits a secondary signal directed at the first gate cabinet and determines one or more of:
a blocked state of the secondary sensor;
a clear state of the secondary sensor; and
a secondary distance of the object to the secondary sensor based on the secondary signal reflected from the object.

3. The width detection system to measure the width of the object at the transit gate of the transit system of claim 1, wherein the controller is further operable to:
compare the primary distance against a secondary threshold; and
actuate the gate paddle if the primary distance is below the secondary threshold.

4. The width detection system to measure the width of the object at the transit gate of the transit system of claim 1, wherein the controller determines the width of the object as a function of the primary distance, a secondary distance, and the aisle width of the transit gate.

5. The width detection system to measure the width of the object at the transit gate of the transit system of claim 1, wherein the controller processes an image corresponding to the object via a machine learning (ML) engine, wherein the ML engine is operable to:
preprocess the image captured via a camera;
extract features from the image; and
locate a plurality of regions of the image to detect the object.

6. The width detection system to measure the width of the object at the transit gate of the transit system of claim 1, wherein the gate paddle is actuated based on one or more of:
the primary threshold;
a secondary threshold; and
processing of an image corresponding to the object based on the primary threshold and the secondary threshold.

7. The width detection system to measure the width of the object at the transit gate of the transit system of claim 1, wherein the sensor system further comprises the primary sensor and a secondary sensor, and wherein the primary sensor and the secondary sensor function as a cross-aisle sensor pair.

8. The width detection system to measure the width of the object at the transit gate of the transit system of claim 1, wherein the transit gate comprises an exit gate of the transit system.

9. A width detection method for measuring a width of an object at a transit gate of a transit system, the width detection method comprises:
controlling access through the transit gate via a gate paddle;
separating a first gate cabinet and a second gate cabinet of the transit gate with an aisle width;
positioning a primary sensor of a sensor system at the first gate cabinet of the transit gate, wherein the primary sensor:
emits a primary signal directed at the second gate cabinet, and
determines a primary distance of the object to the primary sensor based on the primary signal reflected from the object; and
determining, via a controller, the width of the object based on the primary distance and the aisle width, wherein the controller:
compares the width against a primary threshold, and
actuates the gate paddle.

10. The width detection method for measuring the width of the object at the transit gate of the transit system of claim 9, wherein the sensor system further comprises positioning a secondary sensor at the second gate cabinet of the transit gate, wherein the secondary sensor emits a secondary signal directed at the first gate cabinet and determines one or more of:
a blocked state of the secondary sensor;
a clear state of the secondary sensor; and
a secondary distance of the object to the secondary sensor based on the secondary signal reflected from the object.

11. The width detection method for measuring the width of the object at the transit gate of the transit system of claim 9, wherein the controller is further operable to:
compare the primary distance against a secondary threshold; and
actuate the gate paddle if the primary distance is below the secondary threshold.

12. The width detection method for measuring the width of the object at the transit gate of the transit system of claim 9, further comprises determining, via the controller, the width of the object as a function of the primary distance, a secondary distance, and the aisle width of the transit gate.

13. The width detection method for measuring the width of the object at the transit gate of the transit system of claim 9, further comprises processing, via the controller, an image corresponding to the object using a machine learning (ML) engine, wherein the ML engine is operable to:
preprocess the image captured via a camera;
extract features from the image; and
locate a plurality of regions of the image to detect the object.

14. The width detection method for measuring the width of the object at the transit gate of the transit system of claim 9, wherein the gate paddle is actuated based on one or more of:
the primary threshold;
a secondary threshold; and
processing of an image corresponding to the object based on the primary threshold and the secondary threshold.

15. A machine-readable medium having machine-executable instructions embodied thereon that, when executed by one or more processors, facilitate a method for measuring a width of an object at a transit gate of a transit system, the method comprising:
controlling access through the transit gate via a gate paddle;
separating a first gate cabinet and a second gate cabinet of the transit gate with an aisle width;
positioning a primary sensor of a sensor system at the first gate cabinet of the transit gate, wherein the primary sensor:
emits a primary signal directed at the second gate cabinet, and
determines a primary distance of the object to the primary sensor based on the primary signal reflected from the object; and
determining, via a controller, the width of the object based on the primary distance and the aisle width, wherein the controller:
compares the width against a primary threshold, and
actuates the gate paddle.

16. The machine-readable medium facilitating the method for measuring the width of the object at the transit gate of the transit system of claim 15, wherein the sensor system further comprises positioning a secondary sensor at the second gate cabinet of the transit gate, wherein the secondary sensor emits a secondary signal directed at the first gate cabinet and determines one or more of:
a blocked state of the secondary sensor;
a clear state of the secondary sensor; and
a secondary distance of the object to the secondary sensor based on the secondary signal reflected from the object.

17. The machine-readable medium facilitating the method for measuring the width of the object at the transit gate of the transit system of claim 15, wherein the controller is further operable to:
compare the primary distance against a secondary threshold; and
actuate the gate paddle if the primary distance is below the secondary threshold.

18. The machine-readable medium facilitating the method for measuring the width of the object at the transit gate of the transit system of claim 15, further comprises determining, via the controller, the width of the object as a function of the primary distance, a secondary distance, and the aisle width of the transit gate.

19. The machine-readable medium facilitating the method for measuring the width of the object at the transit gate of the transit system of claim 15, further comprises processing, via the controller, an image corresponding to the object using a machine learning (ML) engine, wherein the ML engine is operable to:
preprocess the image captured via a camera;
extract features from the image; and
locate a plurality of regions of the image to detect the object.

20. The machine-readable medium facilitating the method for measuring the width of the object at the transit gate of the transit system of claim 15, wherein the gate paddle is actuated based on one or more of:
the primary threshold;
a secondary threshold; and
processing of an image corresponding to the object based on the primary threshold and the secondary threshold.
